(19) United States
(12) Patent Application Publication
(10) Pub. No.: US 2014/0264096 A1
(43) Pub. Date: Sep. 18, 2014

(54) MULTI-AXIS OPTICAL MEASUREMENT OF FLUID STREAMS WITH SONIC CLEANING AND HOMOGENIZATION

(71) Applicants: Dale Brost, Coarsegold, CA (US); Justin Caplinger, Fresno, CA (US); Amy Foster, Clovis, CA (US); Keith Moffatt, Fresno, CA (US); Wade Peterson, Fresco, CA (US)

(72) Inventors: Dale Brost, Coarsegold, CA (US); Justin Caplinger, Fresno, CA (US); Amy Foster, Clovis, CA (US); Keith Moffatt, Fresno, CA (US); Wade Peterson, Fresco, CA (US)

(21) Appl. No.: 14/213,286

(22) Filed: Mar. 14, 2014

Related U.S. Application Data
(60) Provisional application No. 61/799,725, filed on Mar. 15, 2013.

(51) Int. Cl. G01N 21/05; G01N 23/00

(52) U.S. Cl. CPC G01N 21/05; G01N 23/00
USPC 250/574; 250/576; 250/458.1; 250/459.1

(57) ABSTRACT

The present application is directed to methods and apparatus for multi-axis optical measurements of a fluid stream flowing or contained in an optically transparent measurement chamber. Sonic energy is directed into the fluid in the measurement chamber to clean interior surfaces of the measurement chamber and promote homogenization of the fluid. Optical measurements may be taken of the fluid.

### CROSS-REFERENCE TO RELATED APPLICATIONS

The present application claims priority to provisional U.S. Patent Application Ser. No. 61/799,725, filed on Mar. 15, 2013, titled “No-Solvent Method for Measuring Hydrocarbons in Water and Soil with Fluorescence Detection Instruments and Means for Multi-Axis Optical Measurements of Fluid Streams with Sonic Cleaning and Homogenization,” which is hereby incorporated by reference in its entirety.

### FIELD OF THE INVENTION

The present application is directed generally to apparatus and methods for analytical measurements, and more specifically to apparatus and methods for optical measurements of a fluid.

### BACKGROUND

In the United States alone, the number of producing natural gas wells in service in 2011 is estimated to be 504,000 and the number of producing oil wells is estimated to be 536,000. Due to the continued and expanding use of horizontal drilling combined with hydraulic fracturing, the number of producing oil and gas wells is expected to significantly increase. These drilling techniques allow oil and gas to be extracted from formerly unproductive unconventional formations such as shale deposits or plays and coalbed methane deposits. Each of these wells has the potential to generate large volumes of produced water.

The U.S. Environmental Protection Agency has defined produced water as “the water (brine) brought up from the hydrocarbon bearing formation strata during the extraction of oil and gas, and can include formation water, injection water, and any chemicals added downhole or during the oil/water separation process.” Produced water may contain dissolved inorganic salts and organic compounds, dispersed oil droplets, dissolved gases, bacteria, and dispersed solid particles. Accordingly, environmental regulations are regulating the disposal of these fluids. Proper analysis of the constituents present in produced water is essential to efficiently and cost effectively treat the water.

Many current analytical techniques first require a sample of the produced water to be taken from a pipe or storage tank, and then the analysis performed on the sample. This type of approach provides only a “snapshot” in time of the true characteristics of the produced water stream and does not allow for continuous or real-time analysis. On-line and in-line monitoring systems have been developed for continuous monitoring, but these systems typically suffer from maintenance issues (specifically, fouling of optical surfaces) and homogeneity of the sample being analyzed.

### SUMMARY

The present application is directed to apparatus for multi-axis measurements of a fluid stream. Various embodiments may comprise an optically transparent measurement chamber comprising one or more walls. Each of the walls may have interior and exterior surfaces, and the walls may be arranged to form a hollow interior passage through the measurement chamber capable of receiving fluid therein. The apparatus may further comprise a sonically stimulated collar coupled to the exterior surfaces of the walls. The collar may extend completely or partially around a circumference of the measurement chamber. The collar may be capable of transmitting sonic or ultrasonic vibrations through the walls and into the fluid in the hollow interior passage of the measurement chamber. The apparatus may also comprise at least one source of electromagnetic radiation positioned to direct electromagnetic radiation through the optically transparent measuring chamber and through the liquid. At least one detector may detect electromagnetic radiation transmitted from the hollow interior passage through the walls.

According to additional exemplary embodiments, the present application may be directed to methods for conducting multi-axis optical measurements of a fluid stream. The methods may comprise providing an optically transparent measurement chamber. The measurement chamber may comprise one or more walls, and each of the walls may have interior and exterior surfaces. The walls may be arranged to form a hollow interior passage through the measurement chamber capable of receiving the fluid. A sonically stimulated collar may be coupled to the exterior surfaces of the walls and may extend completely or partially around a circumference of the measurement chamber. The collar may be capable of transmitting sonic or ultrasonic vibrations through the walls and into the fluid in the hollow interior passage of the measurement chamber. A plurality of ports may be created that extend through a sidewall of the collar. One or more sources of electromagnetic radiation may be positioned at one or more of the ports to direct electromagnetic radiation through the optically transparent measurement chamber and through the liquid in the hollow interior passage. One or more detectors may be positioned at the ports to detect electromagnetic radiation transmitted from the hollow interior passage through the optically transparent measurement chamber. One or more characteristics of the fluid stream may be determined based on the detected electromagnetic radiation.

### BRIEF DESCRIPTION OF THE DRAWINGS

FIG. 1 is a schematic diagram of an apparatus for multi-axis measurements of a fluid stream illustrating a round measurement chamber according to various embodiments.

FIG. 2A is a schematic diagram of a portion of a round measurement chamber according to various embodiments.

FIG. 2B is a schematic diagram of a portion of a measurement chamber having a plurality of walls according to various embodiments.

FIG. 3 is a schematic diagram of an apparatus for multi-axis measurements of a fluid stream illustrating a measurement chamber having a plurality of walls according to various embodiments.

FIG. 4 is a schematic diagram of an apparatus for multi-axis measurements of a fluid stream illustrating multiple simultaneous optical measurements according to various embodiments.

FIG. 5 is a schematic diagram of an apparatus for multi-axis measurements of a fluid stream illustrating multiple simultaneous optical measurements according to various embodiments.

FIG. 6 is a schematic diagram of an apparatus for multi-axis measurements of a fluid stream illustrating a plurality of optical fibers coupled to a collar according to various embodiments.

FIG. 7 is a schematic diagram of an apparatus for multi-axis measurements of a fluid stream illustrating a collar without ports according to various embodiments.

FIG. 8 is a schematic diagram of an apparatus for multi-axis measurements of a fluid stream illustrating multiple sets of sonic generators, sonic couplers, and collars according to various embodiments.

FIG. 9 is a schematic diagram of an apparatus for multi-axis measurements of a fluid stream with a sonic coupler positioned within a measurement chamber according to various embodiments.

FIG. 10 is a schematic diagram of an apparatus for multi-axis measurements of a fluid stream with a sonic coupler positioned within a measurement chamber and illustrating multiple simultaneous optical measurements according to various embodiments.

FIG. 11 is a schematic diagram of an apparatus for multi-axis measurements of a fluid stream with a sonic coupler positioned within a measurement chamber and illustrating multiple simultaneous optical measurements according to various embodiments.

FIG. 12 is a flow chart of an exemplary method for conducting multi-axis measurements of a fluid stream according to various embodiments.

FIG. 13 is a flow chart of an exemplary method for conducting multi-axis measurements of a fluid stream according to various embodiments.

### DETAILED DESCRIPTION

The present application is directed to methods and apparatus for conducting multi-axis measurements of a fluid stream. Referring to FIG. 1 and FIGS. 2A and 2B, the apparatus 100 may comprise a measurement chamber 105. The measurement chamber 105 may comprise a single chamber wall 205 as illustrated by FIG. 2A for essentially round- or oval-shaped measurement chambers. In other embodiments as illustrated by FIG. 2B, the measurement chamber 105 may comprise a plurality of walls 205. The walls 205 may be arranged to form a hollow interior passage 140 through the measurement chamber 105. One skilled in the art will recognize that the scope of the present application comprises measurement chambers 105 having essentially any number of walls 205 arranged in essentially any shape and is not limited to the number of walls 205 and shapes illustrated herein. Each wall 205 may comprise an exterior surface 210 and an interior surface 215. A fluid contained in or flowing through the measurement chamber 105 may come into contact with the interior surfaces 215. As shown by the darker arrows in FIG. 1, the fluid may enter or flow through the measurement chamber 105 in any direction.

In various embodiments, the measurement chamber 105 may be optically transparent. Optically transparent means that the material from which the measurement chamber 105 is constructed has the ability to transmit electromagnetic radiation at a frequency appropriate for interacting with the fluid inside the hollow interior passage 140. The measurement chamber 105 may be optically transparent to radio, microwave, infrared, visible, ultraviolet, x-ray, or gamma ray portions of the electromagnetic spectrum, or combinations thereof. The measurement chamber 105 may be constructed of glass, quartz, fused silica, sapphire, diamond, ruby, polymeric material, plastic, or the like or combinations thereof that provide the desired optical properties. Some embodiments of the measurement chamber 105 may be constructed of non-optically transparent materials with optically transparent windows or lenses placed in the walls 205.

A length of the measurement chamber 105 may be selected to meet any particular measurement requirements. In various embodiments, a length of about one inch provides satisfactory results, although longer and shorter length measurement chambers 105 are contemplated. In addition, multiple measurement chambers 105 may be coupled in series, and may be arranged with a common central axis (generally indicated by the darker arrow in FIG. 1).

The apparatus 100 may comprise a sonic generator 110, a sonically stimulated collar 120, and a sonic coupler 115 coupling the sonic generator 110 to the collar 120. The sonic generator 110 may be a transducer of any type known in the art to produce sonic or ultrasonic vibrations. The sonic coupler 115 may direct the vibrations produced by the sonic generator 100 to the collar 120.

The collar 120 may more effectively distribute the sonic or ultrasonic vibrations around the circumference of the measurement chamber 105, and may be constructed of any suitable material with adequate structural properties for suitable transference of sonic energy. The collar 120 may be coupled to the exterior surfaces 210 of the walls 205 of the measurement chamber 105 by any suitable method, including clamping, fusing, braising, heat shrinking, or adhesives. Various embodiments may also employ the use of a liquid, solid or gel coupling agent placed between the collar 120 and the exterior surface 210 of the walls 205.

The collar 120 may also comprise one or more ports 125 positioned through a sidewall of the collar 120. The ports 125 may be voids in the collar 120, or may be completely or partially filled with a material having the optically transparent properties described above for the measurement chamber 105. At least two of the ports 125 may be aligned along a common vertical axis as illustrated in FIG. 3. The lighter arrows running generally right to left in FIG. 3 indicate optical paths along which changes in electromagnetic radiation passing directly through the fluid may be detected. In general, the ports 125 may be positioned at any desired location in the collar 120.

The sonic energy imparted into the measurement chamber 105 may facilitate removal of contaminates deposited on the interior surfaces 215 of the walls 205, or prevent contaminate deposition. Removal of the deposits may help to more fully restore the measurement chamber 105 to its full optical clarity. In addition, the sonic energy may promote more complete homogenization of constituents within the fluid for more consistent and accurate measurements. More complete homogenization is particularly desirable when a constituent such as oil is present in the fluid as a separate phase.

Various embodiments of the apparatus 100, when used in conjunction with photometric or spectrometric analysis devices, may facilitate multiple simultaneous optical measurements in a sonically cleaned and homogenized fluid space. Optical measurements may include fluorescence, transmission, absorption, reflectance, diffuse reflectance, light scattering, or the like or combination thereof. FIG. 4 illustrates an exemplary apparatus 100 with a source of electromagnetic radiation 405 directing electromagnetic radiation through one of the ports 125 in the collar 120. The apparatus 100 may allow simultaneous measurements of transmission by a transmission detector 410 and fluorescence by a fluorescence detector 415 positioned at different ports 125.

FIG. 5 illustrates various embodiments of the apparatus 100 in which fluorescence may be measured at two different wavelengths. The electromagnetic radiation source 405 may be positioned at one port 125. A first fluorescence detector 415 adapted to detect a first wavelength λ1 may be positioned at one port 125 and a second fluorescence detector 505 adapted to detect a second wavelength λ2 may be positioned at another port 125.

As illustrated for various embodiments in FIG. 6, any desired number of ports 125 may be placed in the collar 120. The ability to include a large number of ports 125 is especially practical when using lasers and other focused light sources in conjunction with miniaturized detectors, or when optical fibers (or bundles of optical fibers) are used to carry light beams. FIG. 6 illustrates a single row of optical fibers 605 attached radially around the collar 120. Each optical fiber 605 may carry a separate light beam either into or out of the measurement chamber 105. The collar 120 may be adapted to support any number of optical fibers 605, or any number of rows of optical fibers 605.

As illustrated in FIG. 7, various embodiments of the collar 120 contain no ports 125. The cleaning effect of the sonic energy imparted by the collar 120 may not be limited to only that part of the measurement chamber 105 contained within the bounds of the collar 120. Experimentation has shown that a portion of the interior walls 215 prior to and after the location of the collar 120 experience a similar cleaning effect, as well as homogenization effect. Thus, the light beams 135 may be positioned prior to or after the position of the collar 120, eliminating the need for ports 125 in the collar 120 and allowing the use of optical axes that may otherwise be obstructed by the collar 120.

The apparatus 100 is not limited to a single sonic generator 110, sonic coupler 115, and collar 120. Various embodiments may include multiple sets of these devices. For example, FIG. 8 illustrates a pair of sonic generators 110, sonic couplers 115, and collars 120 coupled to a single measurement chamber 105. These devices may be located immediately after one another, or may be spaced apart on the measurement chamber 105.

In various embodiments described above, the sonic energy produced by the sonic generator 110 may be transmitted by the sonic coupler 115 through the collar 120 and through the walls 205 of the measurement chamber 105 before reaching the fluid. There may be a loss of sonic energy through this path such that an amount of sonic energy delivered to the fluid is substantially less than an amount of sonic energy produced by the sonic generator 110. FIG. 9 illustrates various embodiments of the apparatus 100 in which the sonic coupler 115 delivers the sonic energy directly to the fluid, thereby avoiding much of the energy losses. The sonic coupler 115 may be positioned such that a terminal end 910 and at least a portion of an outer surface 905 of the sonic coupler 115 may be positioned within the hollow interior passage 140 of the measurement chamber 105 and in direct contact with the liquid contained in or flowing through the measurement chamber 105. While FIG. 9 illustrates the sonic generator 110 outside the measurement chamber 105, in various embodiments all or a portion of the sonic generator 110 may be positioned within the measurement chamber 105.

FIG. 9 also illustrates that any number of light beams 135 (light paths) may be positioned around the measurement chamber 105. The light beams 135 may be positioned above (as viewed in FIG. 9) the terminal end 910 of the sonic coupler 115 such that the light path 135 through the measurement chamber 105 is unobstructed by the sonic generator 110 or sonic coupler 115. Similarly, FIGS. 10 and 11 illustrate exemplary embodiments in which a single electromagnetic radiation source 405 may produce a plurality of light paths 135 through the measurement chamber 105, and a plurality of detectors positioned about the measurement chamber 105 to detect the light paths 135, such as the fluorescence detector 415, transmission detector 410, or a combination detector 1005. Although not shown in the figures, various embodiments may comprise multiple electromagnetic radiation sources 405, and multiple sets of electromagnetic radiation sources 405 and various detectors arranged at different planes along a length of the measurement chamber 105.

The embodiments illustrated in FIGS. 9 through 11 may impart a greater amount of sonic energy to the fluid for a given amount of energy input (i.e., electricity) delivered to the sonic generator than, for example, the embodiments of FIG. 1 that comprise a collar 120. Thus, the embodiments of FIG. 9 may more effectively remove contaminates deposited on the interior surfaces 215 of the walls 205, or prevent contaminate deposition, for a given amount of energy input. Since the fluid in the embodiments of FIG. 9 is directly sonicated by the sonic coupler 115, the fluid may more aggressively “scrub” the interior surfaces 215 of the walls 205. Conversely, the energy input for the embodiments of FIG. 9 may be less than the energy input for the embodiments of FIG. 1 for an equivalent level of performance.

FIG. 12 illustrates a general flow chart of various embodiments of a method 1200 for conducting multi-axis optical measurements of a fluid stream. At step 1205, an optically transparent measurement chamber 105 is provided. The measurement chamber 105 may comprise one or more walls 205, and each of the walls 205 may have interior surfaces 215 and exterior surfaces 210. The walls 205 may be arranged to form a hollow interior passage 140 through the measurement chamber 105 capable of receiving the fluid. At step 1210, a sonic generator 110 and a sonic coupler 115 are provided. The sonic coupler 115 may be coupled to the sonic generator 110 and may comprise an outer surface 905 and a terminal end 910. At step 1215, the terminal end and at least a portion of the outer surface of the sonic coupler 115 may be positioned in contact with the fluid in the hollow interior passage 140 within the measurement chamber 105. Sonic energy is generated by the sonic generator 110 and transmitted to the fluid at step 1220. One or more sources of electromagnetic radiation 405 may be positioned at step 1225 to direct electromagnetic radiation through the optically transparent measurement chamber 105 and through the liquid in the hollow interior passage 140. At step 1230, one or more detectors may be positioned to detect electromagnetic radiation transmitted from the hollow interior passage 140 through the optically transparent measurement chamber 105. One or more characteristics of the fluid stream may be determined based on the detected electromagnetic radiation at step 1235.

FIG. 13 illustrates a general flow chart of various embodiments of yet another method 1300 for conducting multi-axis optical measurements of a fluid stream. At step 1305, an optically transparent measuring chamber 105 is provided. The measurement chamber 105 may comprise one or more walls 205, and each of the walls 205 may have interior surfaces 215 and exterior surfaces 210. The walls 205 may be arranged to form a hollow interior passage 140 through the measurement chamber 105 capable of receiving the fluid. At step 1310, a sonically stimulated collar 120 may be coupled to the exterior surfaces 210 of the walls 205 and may extend completely or partially around a circumference of the measurement chamber 105. The collar 120 may be capable of transmitting sonic or ultrasonic vibrations through the walls 205 and into the fluid in the hollow interior passage 140 of the measurement chamber 105. A plurality of ports 125 may be created at step 1315 that extend through a sidewall of the collar 120. One or more sources of electromagnetic radiation 405 may be positioned at one or more of the ports 125 at step 1320 to direct electromagnetic radiation through the optically transparent measurement chamber 105 and through the liquid in the hollow interior passage 140. At step 1325, one or more detectors may be positioned at the ports 125 to detect electromagnetic radiation transmitted from the hollow interior passage 140 through the optically transparent measurement chamber 105. One or more characteristics of the fluid stream may be determined based on the detected electromagnetic radiation at step 1330.

The discussion herein refers to a fluid contained in or flowing through the measurement chamber 105. While the fluid may be a liquid, such as water, the present disclosure uses the term “fluid” to mean any liquid, solid, powder, slurry, suspension, emulsion, dispersion, gel, gas, plasma, or the like or combinations thereof.

Spatially relative terms such as “under”, “below”, “lower”, “over”, “upper”, and the like, are used for ease of description to explain the positioning of one element relative to a second element. These terms are intended to encompass different orientations of the device in addition to different orientations than those depicted in the figures. Further, terms such as “first”, “second”, and the like, are also used to describe various elements, regions, sections, etc. and are also not intended to be limiting. Like terms refer to like elements throughout the description.

As used herein, the terms “having”, “containing”, “including”, “comprising”, and the like are open ended terms that indicate the presence of stated elements or features, but do not preclude additional elements or features. The articles “a”, “an” and “the” are intended to include the plural as well as the singular, unless the context clearly indicates otherwise.

The present invention may be carried out in other specific ways than those herein set forth without departing from the scope and essential characteristics of the invention. The present embodiments are, therefore, to be considered in all respects as illustrative and not restrictive, and all changes coming within the meaning and equivalency range of the appended claims are intended to be embraced therein.

What is claimed is:

1. An apparatus for multi-axis optical measurements of a fluid stream, comprising:
an optically transparent measurement chamber comprising one or more walls, each of the one or more walls having interior and exterior surfaces and arranged to form a hollow interior passage through the measurement chamber capable of receiving a fluid therein;
a sonic coupler to transmit sonic energy from a sonic generator to the fluid, the sonic coupler having an outer surface and a terminal end in contact with the fluid within the measurement chamber;
at least one source of electromagnetic radiation positioned to direct electromagnetic radiation through the optically transparent measuring chamber and through the liquid in the hollow interior passage; and
at least one detector to detect electromagnetic radiation transmitted from the hollow interior passage through the one or more walls.

2. The apparatus of claim 1, wherein a frequency of the electromagnetic radiation is selected to provide a predetermined interaction with the fluid in the measurement chamber.

3. The apparatus of claim 2, wherein the frequency of the electromagnetic radiation is selected from a radio, microwave, infrared, visible, ultraviolet, x-ray, or gamma ray portion of the electromagnetic spectrum, or combinations thereof.

4. The apparatus of claim 2, wherein the predetermined interaction with the fluid comprises fluorescence, transmission, absorption, reflectance, diffuse reflectance, light scattering, or the like or combination thereof.

5. The apparatus of claim 1, wherein the optically transparent measurement chamber comprises glass, quartz, fused silica, sapphire, diamond, ruby, polymeric material, plastic, or the like or combinations thereof.

6. The apparatus of claim 1, wherein the fluid comprises a liquid, solid, powder, slurry, suspension, emulsion, dispersion, gel, gas, plasma, or the like or combinations thereof.

7. The apparatus of claim 1, wherein a length of the measurement chamber is about 1 inch or less.

8. The apparatus of claim 1, further comprising more than one sonically stimulated collar coupled to the exterior surfaces of the one or more walls.

9. The apparatus of claim 1, further comprising more than one measurement chamber.

10. The apparatus of claim 9, wherein the more than one measurement chambers are coupled together along a common linear axis.

11. An apparatus for multi-axis optical measurements of a fluid stream, comprising:
an optically transparent measurement chamber comprising one or more walls, each of the one or more walls having interior and exterior surfaces and arranged to form a hollow interior passage through the measurement chamber capable of receiving a fluid therein;
a sonically stimulated collar coupled to the exterior surfaces of the one or more walls and extending around at least a portion of a circumference of the measurement chamber and capable of transmitting sonic or ultrasonic vibrations through the one or more walls and into the fluid in the hollow interior passage of the measurement chamber;
at least one source of electromagnetic radiation positioned to direct electromagnetic radiation through the optically transparent measuring chamber and through the liquid in the hollow interior passage; and
at least one detector to detect electromagnetic radiation transmitted from the hollow interior passage through the one or more walls.

12. The apparatus of claim 11, wherein the collar further comprises a plurality of ports extending through a sidewall of the collar to allow electromagnetic radiation to pass through the measurement chamber.

13. The apparatus of claim 12, wherein at least two of the ports are axially aligned with one another.

14. The apparatus of claim 11, wherein a frequency of the electromagnetic radiation is selected to provide a predetermined interaction with the fluid in the measurement chamber.

15. The apparatus of claim 14, wherein the frequency of the electromagnetic radiation is selected from a radio, microwave, infrared, visible, ultraviolet, x-ray, or gamma ray portion of the electromagnetic spectrum, or combinations thereof.

16. The apparatus of claim 14, wherein the predetermined interaction with the fluid comprises fluorescence, transmission, absorption, reflectance, diffuse reflectance, light scattering, or the like or combination thereof.

17. The apparatus of claim 11, wherein the optically transparent measurement chamber comprises glass, quartz, fused silica, sapphire, diamond, ruby, polymeric material, plastic, or the like or combinations thereof.

18. The apparatus of claim 11, wherein the fluid comprises a liquid, solid, powder, slurry, suspension, emulsion, dispersion, gel, gas, plasma, or the like or combinations thereof.

19. The apparatus of claim 11, wherein a length of the measurement chamber is about 1 inch or less.

20. The apparatus of claim 11, further comprising more than one sonically stimulated collar coupled to the exterior surfaces of the one or more walls.

21. The apparatus of claim 11, further comprising more than one measurement chamber.

22. The apparatus of claim 21, wherein the more than one measurement chambers are coupled together along a common linear axis.

23. The apparatus of claim 21, further comprising a sonically stimulated collar coupled to each of the more than one measurement chamber.

24. The apparatus of claim 11, wherein the at least one source of electromagnetic radiation is spaced apart from the collar.

25. An apparatus for multi-axis measurements of a fluid stream, comprising:
an optically transparent measurement chamber comprising one or more walls, each of the one or more walls having interior and exterior surfaces and arranged to form a hollow interior passage through the measurement chamber capable of receiving a fluid therein;
a sonically stimulated collar coupled to the exterior surfaces of the one or more walls and extending around at least a portion of a circumference of the measurement chamber and capable of transmitting sonic or ultrasonic vibrations through the one or more walls and into the fluid in the hollow interior passage of the measurement chamber;
a plurality of ports extending through a sidewall of the collar;
one or more sources of electromagnetic radiation positioned at one or more of the ports to direct electromagnetic radiation through the optically transparent measuring chamber and through the liquid in the hollow interior passage; and
one or more detectors positioned at one or more of the ports to detect electromagnetic radiation transmitted from the hollow interior passage through the one or more walls.

26. The apparatus of claim 25, wherein at least two of the ports are axially aligned with one another.

27. The apparatus of claim 25, wherein a frequency of the electromagnetic radiation is selected to provide a predetermined interaction with the fluid in the measurement chamber.

28. The apparatus of claim 27, wherein the frequency of the electromagnetic radiation is selected from a radio, microwave, infrared, visible, ultraviolet, x-ray, or gamma ray portion of the electromagnetic spectrum, or combinations thereof.

29. The apparatus of claim 27, wherein the predetermined interaction with the fluid comprises fluorescence, transmission, absorption, reflectance, diffuse reflectance, light scattering, or the like or combination thereof.

30. The apparatus of claim 25, wherein the optically transparent measurement chamber comprises glass, quartz, fused silica, sapphire, diamond, ruby, polymeric material, plastic, or the like or combinations thereof.

31. The apparatus of claim 25, wherein the fluid comprises a liquid, solid, powder, slurry, suspension, emulsion, dispersion, gel, gas, plasma, or the like or combinations thereof.

32. The apparatus of claim 25, wherein a length of the measurement chamber is about 1 inch or less.

33. The apparatus of claim 25, further comprising more than one sonically stimulated collar coupled to the exterior surfaces of the one or more walls.

34. The apparatus of claim 25, further comprising more than one measurement chamber.

35. The apparatus of claim 34, wherein the more than one measurement chambers are coupled together along a common linear axis.

36. The apparatus of claim 34, further comprising a sonically stimulated collar coupled to each of the more than one measurement chamber.

37. The apparatus of claim 25, wherein the one or more sources of electromagnetic radiation are spaced apart from the collar.

38. A method for conducting multi-axis optical measurements of a fluid stream, comprising:
providing an optically transparent measurement chamber comprising one or more walls, each of the one or more walls having interior and exterior surfaces and arranged to form a hollow interior passage through the measurement chamber capable of receiving a fluid therein;
providing a sonic generator and a sonic coupler coupled to the sonic generator, the sonic coupler comprising an outer surface and a terminal end;
positioning the terminal end and at least a portion of the outer surface of the sonic coupler in contact with the fluid in the hollow interior passage within measurement chamber;
generating sonic energy by the sonic generator and transmitting the sonic energy to the fluid;
positioning one or more sources of electromagnetic radiation to direct electromagnetic radiation through the optically transparent measurement chamber and through the liquid in the hollow interior passage;
positioning one or more detectors to detect electromagnetic radiation transmitted from the hollow interior passage through the optically transparent measurement chamber; and
determining one or more characteristics of the fluid stream based on the detected electromagnetic radiation.

39. The method of claim 38, wherein the one or more characteristics of the fluid stream comprise fluorescence, transmission, absorption, reflectance, diffuse reflectance, light scattering, or the like or combinations thereof.

40. The method of claim 38, further comprising removing deposits of contaminates from the interior surfaces of the one or more walls.

41. The method of claim 38, further comprising preventing deposition of contaminates on the interior surfaces of the one or more walls.

42. The method of claim 38, wherein the optical measurements are conducted while the fluid is in a flowing state within the measurement chamber.

43. The method of claim 38, wherein the optical measurements are conducted while the fluid is in a static state within the measurement chamber.

44. The apparatus of claim 38, wherein the fluid comprises a liquid, solid, powder, slurry, suspension, emulsion, dispersion, gel, gas, plasma, or the like or combinations thereof.

45. A method for conducting multi-axis optical measurements of a fluid stream, comprising:
providing an optically transparent measurement chamber comprising one or more walls, each of the one or more walls having interior and exterior surfaces and arranged to form a hollow interior passage through the measurement chamber capable of receiving a fluid therein;
coupling a sonically stimulated collar to the exterior surfaces of the one or more walls and extending around at least a portion of a circumference of the measurement chamber and capable of transmitting sonic or ultrasonic vibrations through the one or more walls and into the fluid in the hollow interior passage of the measurement chamber;
creating a plurality of ports extending through a sidewall of the collar;
positioning one or more sources of electromagnetic radiation at one or more of the ports to direct electromagnetic radiation through the optically transparent measurement chamber and through the liquid in the hollow interior passage;
positioning one or more detectors at one or more of the ports to detect electromagnetic radiation transmitted from the hollow interior passage through the optically transparent measurement chamber; and
determining one or more characteristics of the fluid stream based on the detected electromagnetic radiation.

46. The method of claim 45, wherein the one or more characteristics of the fluid stream comprise fluorescence, transmission, absorption, reflectance, diffuse reflectance, light scattering, or the like or combinations thereof.

47. The method of claim 45, further comprising removing deposits of contaminates from the interior surfaces of the one or more walls.

48. The method of claim 45, further comprising preventing deposition of contaminates on the interior surfaces of the one or more walls.

49. The method of claim 45, wherein the optical measurements are conducted while the fluid is in a flowing state within the measurement chamber.

50. The method of claim 45, wherein the optical measurements are conducted while the fluid is in a static state within the measurement chamber.

51. The apparatus of claim 45, wherein the fluid comprises a liquid, solid, powder, slurry, suspension, emulsion, dispersion, gel, gas, plasma, or the like or combinations thereof.
